(19) United States
(12) Patent Application Publication
(10) Pub. No.: US 2024/0310557 A1
(43) Pub. Date: Sep. 19, 2024

(54) UNIT CELL, PHASE-TUNABLE METASURFACE AND OPTICAL SYSTEM

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/676,455

(22) Filed: May 28, 2024

Related U.S. Application Data
(63) Continuation of application No. PCT/CN2022/143114, filed on Dec. 29, 2022.

(30) Foreign Application Priority Data
Jan. 12, 2022 (CN) 202210032916.X

(51) Int. Cl. G02B 1/00; G02F 1/00; G02F 1/01

(52) U.S. Cl. CPC G02B 1/002; G02F 1/0018; G02F 1/0102; G02B 2207/101; G02F 2202/30

(57) ABSTRACT

A unit cell, a phase-tunable metasurface and an optical system are provided by this disclosure. The unit cell includes: an electrode layer, an electrical actuating layer and a nanostructure; the nanostructure is a sub-wavelength structure; the electrode layers are setting on the both sides of the electrical actuating layer; the nanostructure is setting on the one side of the electrode layer away from the electrical actuating layer, the electrical actuating layer can move in the height axial direction of the nanostructure under the action of the electric field provided by the electrode layer.

### CROSS-REFERENCE TO RELATED APPLICATIONS

This disclosure is a continuation of International Patent disclosure of PCT disclosure serial No. PCT/CN2022/143114, filed on Dec. 29, 2022, which claims the benefit of priority from Chinese application No. 202210032916.X, filed on Jan. 12, 2022. The content of the aforementioned disclosures, including any intervening amendments thereto, are incorporated herein by reference.

### TECHNICAL FIELD

The present disclosure relates to the field of a metasurface, in particular to a unit cell, a phase-tunable metasurface and an optical system.

### BACKGROUND

Metasurface is a kind of planar structure with sub-wavelength nanostructures. Sub-wavelength structure refers to structures with dimensions close to or less than the working wavelength.

In the related technology, the shape, size and arrangement of the nanostructures are designed according to the waveband of the incident light, so that the metasurface can modulate the incident light. The nanostructure of the metasurface is pre-designed by the waveband of the incident light to be modulated and the substrate of the metasurface is usually a planar structure, so the phase of the metasurface is also pre-designed.

Therefore, the phase of the metasurface is changeless in the related technology and cannot be actively modulated according to the application requirements, so the related technology cannot actively change the modulation method of the incident light.

### SUMMARY

In view of the above technical problems that the present metasurface cannot actively modulate the phase according to the application requirements, a unit cell, a phase-tunable metasurface and an optical system are provided according to embodiments of the present disclosure, so as to overcome the problems in the related art.

In the first aspect, a unit cell is provided by the embodiment of the present disclosure, the unit cell includes: an electrode layer, an electrical actuating layer and a nanostructure;

where, the nanostructure is a sub-wavelength structure;

the electrode layers are setting on the both sides of the electrical actuating layer;

the nanostructure is setting on the one side of the electrode layer away from the electrical actuating layer;

the electrical actuating layer is capable of moving in the height axial direction of the nanostructure under the action of the electric field provided by the electrode layer.

Optionally, the unit cell further includes: a reflective layer;

where the reflective layer is set on the side of the electrode layer facing the incident light;

the nanostructure is setting on the side of the reflective layer away from the electrode layer.

Optionally, the unit cell further includes: a matching layer;

where the matching layer is setting on the side of the reflective layer away from the electrode layer;

the nanostructure is setting on the side of the matching layer away from the reflective layer. Optionally, a periodicity of the unit cell is greater than or equal to 0.32 λc, and less than or equal to λc;

λc is the central wavelength of the incident light.

Optionally, a height of the nanostructure is greater than or equal to 0.3 λc, and less than or equal to λc;

λc is the central wavelength of the incident light.

Optionally, a thickness of the reflective layer is greater than or equal to 30 nm, and less than or equal to 200 nm.

Optionally, a thickness of the matching layer is greater than or equal to 10 nm, and less than or equal to 200 nm.

Optionally, the electrical actuating layer includes: MEMS or piezoelectric ceramics.

Optionally, the extinction coefficients for the incident light of the electrode layer and the electrical actuating layer are less than or equal to 0.1.

Optionally, the electrical actuating layer includes: indium tin oxide.

Optionally, a thickness of the electrode layer is greater to 10 nm.

In the second aspect, a phase-tunable metasurface is provided by the embodiment of the present disclosure, where the phase-tunable metasurface includes the unit cell.

Optionally, the unit cells are arranged in array.

Optionally, the phase tunable metasurface further comprises: a filler material, the filler material is configured to fill a gap between any two nanostructures in the metalens;

where, the filler material includes fluid with an extinction coefficient less than or equal to 0.1 for the incident light.

Optionally, the filler material is air.

Optionally, the filler material is non-air fluid;

the absolute value of the difference between the refractive index of the non-air fluid and the nanostructure is greater than or equal to 0.5.

Optionally, the height of the electrical actuating layer is greater than or equal to 10 times of the central wavelength of the incident light.

Optionally, the movement of the electrical actuating layer in the height axial direction satisfies at least:

$${n}_{F} ( {λ}_{c} ) \cdot Δ d \geq \frac{{λ}_{c}}{2}$$

where the n_{F}(λ_{c}) is the refractive index of the filler material of the incident light at the central wavelength; Δd is the maximum displacement of movement for the electrical actuating layer, λ_{c} is the central wavelength of the incident light.

Optionally, the maximum displacement of movement for the electrical actuating layer is less than or equal to 500 nm.

In the third aspect, an optical system is provided by the embodiment of the present disclosure, the optical system includes the phase-tunable metasurface.

According to the unit cell, the phase-tunable metasurface and the optical system provided by the embodiment of the present disclosure, the electrode layers are setting on the both sides of the electrical actuating layer, the electrical actuating layer can move in the height axial direction of the nanostructure under the action of the electric field provided by the electrode layer.

In the unit cell, phase-tunable metasurface and optical system provided by the present disclosure, the electrical actuating layer can move under the action of the electric field provided by the electrode layer. And the electrode layer is setting on the both sides of the electrical actuating layer. And then the electrode layer drives the nanostructure to move in the height axial direction, so as to modulate phase of the unit cells by modulating the nanostructure. Modulating the nanostructure can achieve an active modulation of the phase-tunable metasurface. The metasurface of the present disclosure includes the unit cells mentioned above, and the modulation of the unit cell can utilize a wide range of the phase modulation to the metasurface. Since any one unit cell can be modulated, the phase-tunable metasurface provided by the embodiment of the present disclosure can realize a precise phase modulation.

### BRIEF DESCRIPTION OF THE DRAWINGS

In order to explain more clearly, the technical scheme in the application technology or the background technology, the attached drawings required in the application embodiment or the background technology will be explained below.

FIG. 1 shows a perspective view of an optional structure of the unit cell provided by the embodiment of the present disclosure;

FIG. 2 shows a side view of an optional structure of a phase-tunable metasurface provided by the embodiment of the present disclosure;

FIG. 3 shows an optional perspective view of a filler material of the phase-tunable metasurface provided by the embodiment of the present disclosure;

FIG. 4 shows a side view of an optional structure of a phase-tunable metasurface provided by the embodiment of the present disclosure;

FIG. 5 shows an optional perspective view of the phase-tunable metasurface provided by the embodiment of the present disclosure;

FIG. 6 shows a side view of an optional structure of a phase-tunable metasurface provided by the embodiment of the present disclosure;

FIG. 7 shows a side view of an optional structure of a unit cell in a phase-tunable metasurface provided by the embodiment of the present disclosure;

FIG. 8 shows a top view of an optional structure of a phase-tunable metasurface provided by the embodiment of the present disclosure;

FIG. 9 shows a top view of an optional structure of a phase-tunable metasurface provided by the embodiment of the present disclosure;

FIG. 10 shows a top view of an optional structure of a phase-tunable metasurface provided by the embodiment of the present disclosure;

FIG. 11 shows the relationship between the displacement of movement for the electrical actuating layer and the variation of phase in the phase-tunable metasurface provided by the embodiment of the present disclosure;

FIG. 12 shows the changing relationship between the diameter of the nanostructure, the electrical actuating layer, and the variation of phase of the incident light at the 940 nm working wavelength;

FIG. 13 shows an optical system provided by the embodiment of the present disclosure;

FIG. 14 shows an optional optical system provided by the embodiment of the present disclosure;

FIG. 15 shows an optional optical system provided by the embodiment of the present disclosure;

FIG. 16 shows the phase along the radius direction when the focal length of the optical system is 8 mm in the present disclosure embodiment;

FIG. 17 shows the displacement of the movement along the radius direction for the electrical actuating layer when the focal length of an optical system changes in a range of 6 mm to 12 mm.

### DETAILED DESCRIPTION OF THE EMBODIMENTS

In order to make the purpose, technical solution and advantages of the present disclosure clearer, the embodiment of the present disclosure will be further described in detail below in combination with the attached drawings. It should be noted that, unless otherwise clearly specified and defined, the terms “installed”, “connected”, “connected” and “connection” should be generally understood, such as fixed connection or disassembled connection; mechanical or electrical connection, or indirectly through an intermediate medium, or within the two components. For those of ordinary skill in the art, the above terms may be understood in the embodiment of this disclosure.

In addition, terms “first” and “second” are used for descriptive purposes, and are not intended to indicate or imply relative importance or implicitly indicate the quantity of the indicated technical features. Therefore, features defined by “first” or “second” may explicitly or implicitly include one or more of these features. In the description of the present disclosure, “plurality” or “multiple” means that there are two or more of these features, unless otherwise explicitly and specifically defined.

The embodiment of this disclosure is described below in combination with the accompanying drawings in the embodiment of the present disclosure.

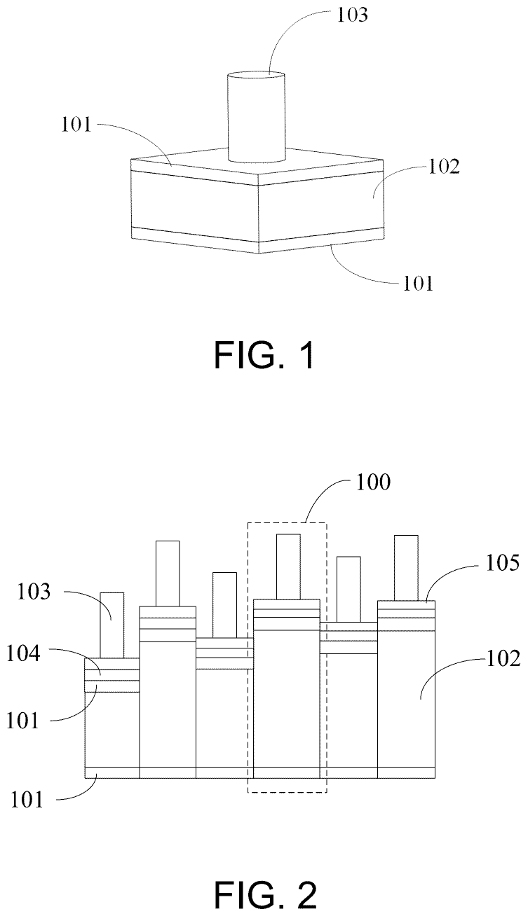

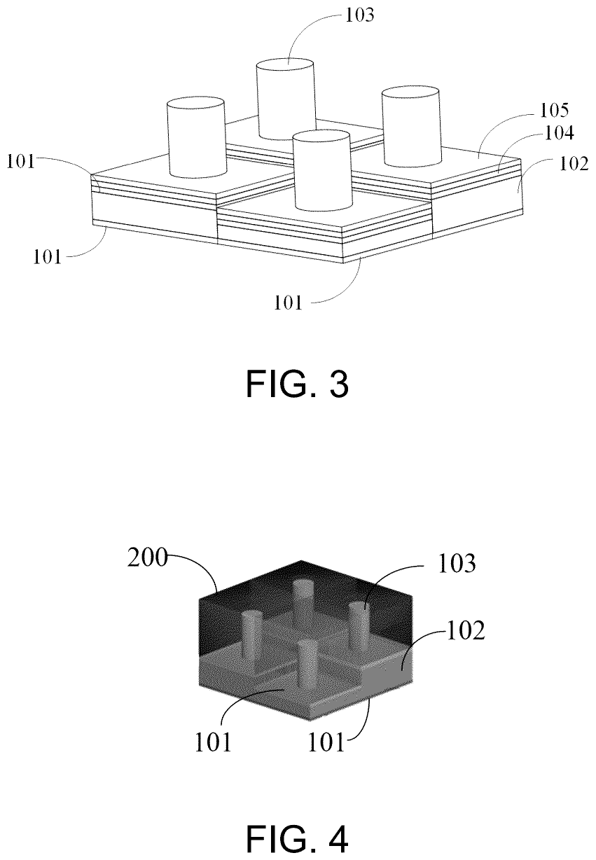

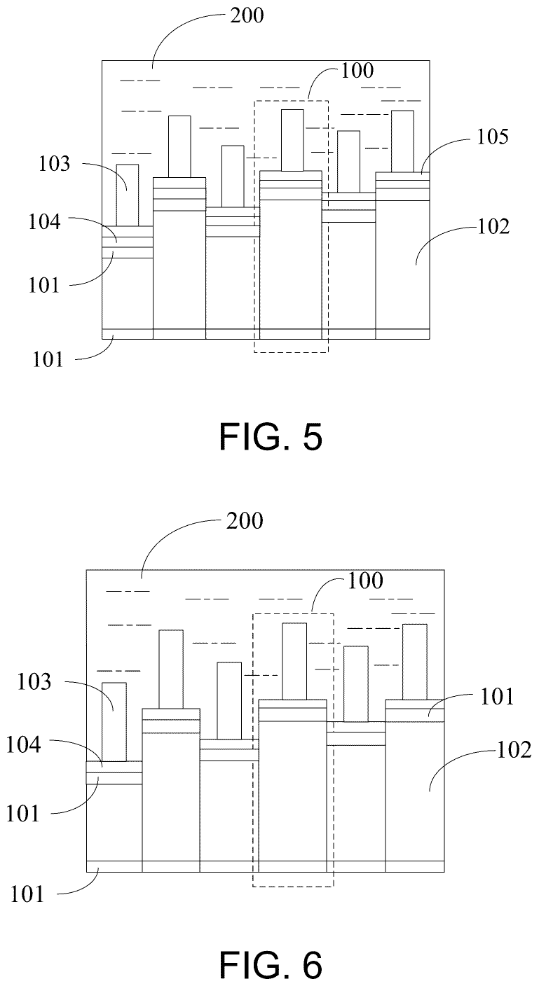

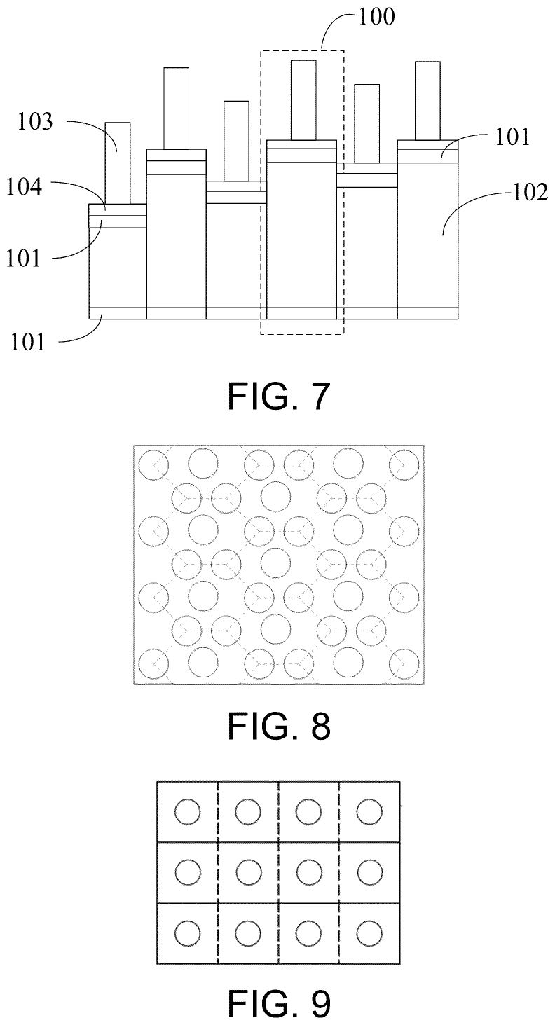

In order to achieve accurate and large-scale modulation of the metasurface phase, the metasurface can actively change the modulation method of the incident light by the application requirements. As shown in FIG. 1, a unit cell 100 is provided by the present disclosure. The unit cell 100 includes: an electrode layer 101, an electrical actuating layer 102 and a nanostructure 103. And the electrode layers 101 are setting on the both sides of the electrical actuating layer 102. The nanostructure 103 is setting on the one side of the electrode layer 101 away from the electrical actuating layer 102. The electrical actuating layer 102 can move in the height axial direction of the nanostructure 103 under the action of the electric field provided by the electrode layer 101. And the nanostructure is a sub-wavelength structure.

It should be understood that the nanostructure 103 is full dielectric medium nanostructure. For example, when the incident light is visible light, the materials of the nanostructures 103 may include titanium oxide, silicon nitride, molten quartz, alumina, gallium nitride, gallium phosphates, and hydrogenated amorphous silicon, etc. In this embodiment, the nanostructure may be a polarization-dependent structure, such as nanopillar fins or nano elliptical column, and the polarization-dependent structure can apply a Pancharatnam-Berry Phase to the incident light. And the nanostructure may be a polarization-independent structure, such as nano cylinder or nano square column, and the polarization-independent structure can apply a Propagation Phase to the incident light.

Specifically, the unit cell provided by the embodiment of the present disclosure uses electrical actuating layer 102 as the substrate. And the electrode layers 101 are setting on the both sides of the electrical actuating layer 102. The nanostructure 103 is setting on the one side of the electrode layer 101 away from the electrical actuating layer 102. The electrical actuating layer 102 can move in the height axial direction of the nanostructure 103 under the action of the electric field provided by the electrode layer 101, so as to adjust the height of the nanostructure. That is to say, the present disclosure adopts height-tunable substrate to utilize the adjustment of the height of the nanostructure.

It should be understood that the electrical actuating layer 102 and the electrode layer 101 may be a transparent or a non-transparent material to the incident light. When the unit cell 100 requires to transmite the incident light, the electrical actuating layer 102 and the electrode layer 101 are transparent to the incident light. For example, the electrical actuating layer 102 may be PLZT (lanthanum modified lead titanate zirconate). Also, the electrode layer 101 may be a transparent oxide, such as an indium tin oxide. It should be understood that the “transparent to the incident light” means that the extinction coefficient for the incident light of the the material is less than or equal to 0.1. In one embodiment, the the extinction coefficient for the incident light of the the material is less than or equal to 0.01. In one embodiment, the thickness of the electrode layer 101 is in a range of 10 nm to a few μm.

In one embodiment, the electrical actuating layer 102 includes MEMS (Micro-Electro-Mechanical System) or piezoelectric ceramics. For example, the electrical actuating layer 102 may be piezoelectric ceramics. The electrical actuating layer 102 can be elongated when electrode layer 101 applies a positive voltage to the electrical actuating layer 102. And the electrical actuating layer 102 can be shortened when the electrode layer 101 applies a negative voltage to the electrical actuating layer 102.

In a further embodiment of the present disclosure, the unit cell further includes a reflective layer 104. The reflective layer 104 is setting on the side of the electrode layer 101 away from the electrical actuating layer 102, and the nanostructure 103 is setting on the side of the reflective layer 104 away from the electrode layer 101. The reflective layer 104 is used to realize the modulation and reflection to the incident light. Further more, the unit cell 100 includes: a matching layer 105, and the matching layer 105 is setting on the side of the reflective layer 104 away from the electrode layer 101. The nanostructure 103 is setting on the side of the matching layer 105 away from the reflective layer 104. And the matching layer 105 is used to improve the reflectivity of the unit cell 100.

In one optional embodiment, the a periodicity of the unit cell is greater than or equal to 0.32 λc, and less than or equal to λc. And λc is the central wavelength of the incident light. Optionally, when the wavelength is 940 nm, the range of the periodicity of the unit cell is from 280 nm to 940 nm. In one embodiment, the range of the periodicity of the unit cell 100 is from 400 nm to 550 nm. For example, the height of the nanostructure 103 is greater or equal to 0.32 λc, and is less than or equal to 2 λc. Optionally, when the wavelength is 940 nm, the range of the height of the nanostructure 103 is from 500 nm to 600 nm.

In one optional embodiment, the thickness of the reflective layer 104 is in a range of 30 nm to 200 nm. In some embodiment, the thickness of the matching layer 105 is in a range of 10 nm to 200 nm.

Therefore, the unit cell provided by the present disclosure drives the electrical actuating layer to move, so as to realize the height adjustment of a single nanostructure.

The present disclosure provides a phase-tunable metasurface, wherein the phase-

tunable metasurface includes the unit cell 100 arranged in array.

Specifically, the metasurface modulates the phase, amplitude and polarization of the incident light by the nanostructure arranged in array. In the present disclosure, the phase-tunable metasurface is composed of the unit cells 100, and the unit cells are arranged in array. The unit cell 100 may modulate the height of the nanostructure by the electrical actuating layer, so as to change the nanostructure array on the metasurface. Different nanostructure arrays correspond to different phase of the metasurface, and different phase of the metasurface has different modulation to the incident light. The phase-tunable metasurface provided by the present disclosure may be a reflective metasurface, or may be a transmittive metasurface.

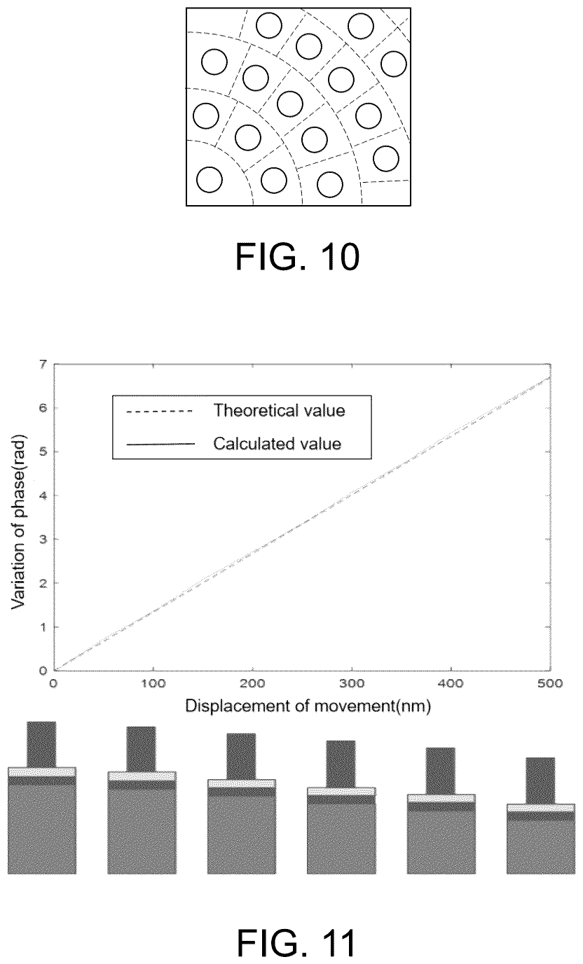

In some embodiment of the present disclosure, the unit cells 100 are arranged in array with a densely packed pattern, so that the nano-structure is arranged at a vertex and/or center position of the densely packed pattern. For example, as shown in FIG. 8-FIG. 10 the densely packed pattern includes one or more shapes, such as, a regular hexagon, a square, or a fan shape. Optionally, the periodicity of the unit cell may be different from the periodicity of the densely packed pattern, as shown in FIG. 8. In FIG. 8, the densely packed pattern is a regular hexagon, and the nanostructure 103 is located at the center of the densely packed pattern. For example, in the unit cell 100, when the electrode layer 101, the electrical actuating layer 102, the reflection layer 104, and the matching layer 105 are perpendicular to the height axis of the nanostructure 103, the section views are square or fan-shaped. And the top view of the phase-tunable metasurface is shown as FIG. 9 or FIG. 10.

When the unit cell 100 of the phase-tunable metasurface is arranged in array, there are inevitably gaps between the adjacent nanostructures 103. The gaps between the nanostructures 103 may be filled by a filler material, the filler material is configured to fill a gap between any two nanostructures in the metalens. And the filler material includes fluid with an extinction coefficient less than or equal to 0.1 for the incident light.

If the filler material is air, the manufacturing process of the phase-tunable metasurface is simple and the production cost of the phase-tunable metasurface is low. However, when the filler material is air, the dispersion of the phase-tunable metasurface is only determined by the dispersion of the nanostructure 103. That is to say, the dispersion of the phase-tunable metasurface which uses this structure can not be modulated.

To achieve dispersion modulation of the phase tunable metasurface provided by the embodiment of this disclosure, the gaps between the nanostructures 103 may be filled with non-air fluid. Optionally, the the filler material is fluid. When the height of the unit cell changes, the filler material 200 will flow to fill the gaps between the nanostructures 103. Meanwhile, the filler material 200 will flat the upper surface of the unit cell 100. The dispersion of the phase-tunable metasurface of the structures are determined by the dispersion of the nanostructures 103 and the filler material 200. That is, the dispersion of the phase-tunable metasurface of such structures can be modulated. It should be noted that the filler material is non-air fluid, the absolute value of the difference between the refractive index of the non-air fluid and the nanostructure is greater than or equal to 0.5.

Further, in order to precisely modulate the phase of the phase-tunable metasurface provided by the application embodiment by adjusting the unit cell 100, the height of the electrical actuating layer 102 of the unit cell 100 can be greater than or equal to the center wavelength of the incident light. Further more, in order to cover the phase modulation range of the phase-tunable metasurface by 2π, and the displacement of movement for the electrical actuating layer 102 in the height axial direction of the nanostructure 103 satisfies at least:

$${n}_{F} ( {λ}_{c} ) \cdot Δ d \geq \frac{{λ}_{c}}{2} \qquad ( 2 )$$

where, the n_{F}(λ_{c}) is the refractive index of the filler material of the incident light at the central wavelength; Δd is the maximum displacement of movement for the electrical actuating layer, λ_{c} is the central wavelength of the incident light. In one embodiment, the incident light includes wavebands of visible light, near-infrared, mid-infrared, or far-infrared, etc.

In one embodiment, when the central wavelength of the incident light is 940 nm and the filler material between the nanostructures 103 is air in the phase-tunable metasurface, the variation relationship between the displacement of movement for the electrical actuating layer 102 in the phase-tunable metasurface and the variation of phase is shown as FIG. 11. According to FIG. 11, in the phase-tunable metasurface, the displacement of movement for the unit cell 100, the theoretical value of the variation of phase modulation and the numerical simulation results have highly degree of conformity. And, in FIG. 11, the phase modulation range of the phase-tunable metasurface covers 2π.

It should be understood that the electrical actuating layer shortened along the height axial direction of the nanostructure 103 is the positive displacement of movement in this embodiment. Conversely, the electrical actuating layer enlarged along the height axial direction of the nanostructure 103 is the negative displacement of movement. And the “positive” and “negative” just indicate the different direction of the displacement of movement. In one embodiment, the displacement of movement for the electrical actuating layer is less than or equal to 500 nm.

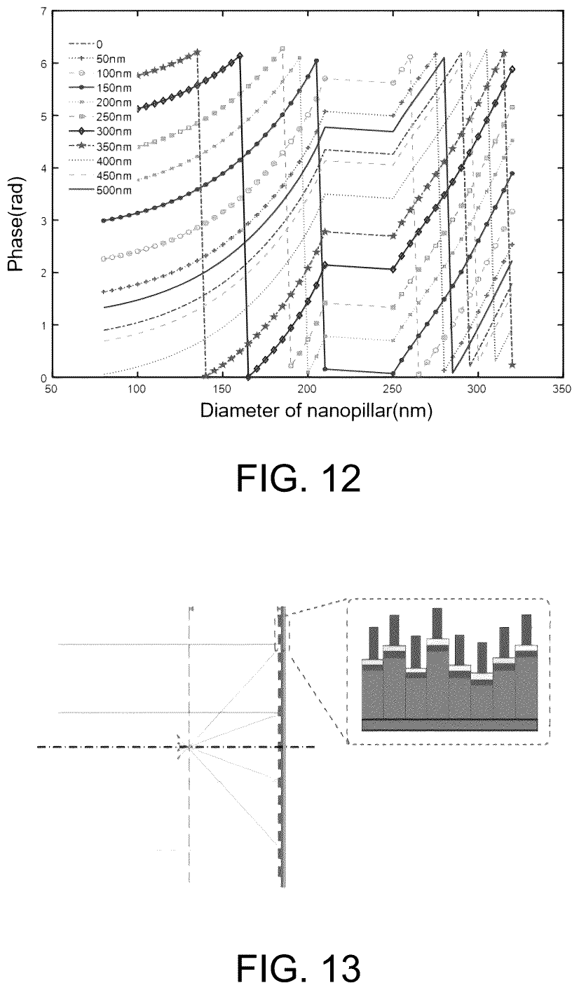

Considering the effect of the shape and size of the nanostructures on the metasurface phase, this embodiment of the present disclosure uses the cylindrical nanostructure 103 as an example and shows the relationship between the diameter of the nanostructure 103, the electrical actuating layer 102, and the variation of phase of incident light at a working wavelength of 940 nm, as shown in FIG. 12. According to FIG. 12, the phase modulation of the phase-tunable metasurface to incident light by the displacement of movement of the electrical actuating layer 102 may cover the phase of entire 2π.

It should be noted that the unit cell 100 and the phase-tunable metasurface contained the unit cell 100 can be both produced by semiconductor process. That is to say, in the phase-tunable metasurface provided by the present embodiment, the unit cells 100 arranged in array have the same height in the initial state, which means that the phase-tunable metasurface is a metasurface with a planar substrate in the initial state. When phase modulation is applied to the phase-tunable metasurface, the height of some or all unit cells 100 will change. At this moment, the phase-tunable metasurface is substantially a metasurface with a non-planar substrate.

Therefore, the phase-tunable metasurface provided by the embodiment of the disclosure actively modulates the phase of the entire phase-tunable metasurface and adjusts the height of the unit cell by arranging the array of the unit cell. Since the height of each unit cell can be modulated, the phase-tunable metasurface can be precisely modulated.

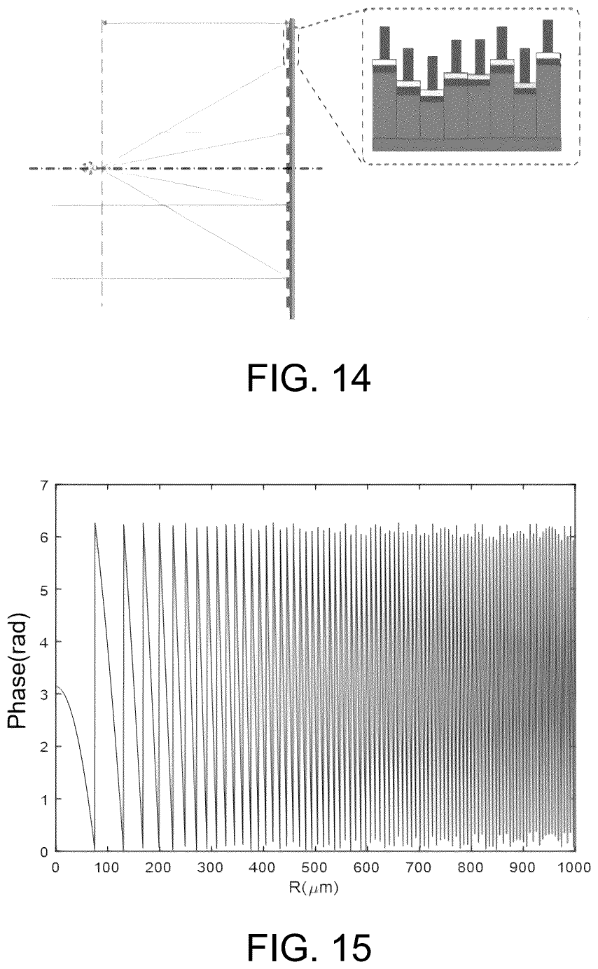

An optical system is provided be the present disclosure as shown in FIG. 13-FIG. 14, and the optical system includes any phase-tunable metasurface provided by any of the above-mentioned embodiments.

The optical system provided in an embodiment of the disclosure is a reflective zoom metalens that includes a phase-tunable metasurface provided in any one embodiment of the disclosure as shown from FIG. 13 to FIG. 14.

The working wavelength of the reflective zoom metalens is 940 nm. And the periodicity of the unit cells 100 in the reflective zoom metalens are in regular square with side length of 400 nm. The nanostructure 103 is a cylindrical structure made of crystalline silicon with a height of 400 nm. The filler material between the nanostructures 103 is air. The reflective zoom metalens includes a matching layer 105 and a reflective layer 104. The reflecting layer 104 is made of gold with thickness of 30 nm, and the matching layer 105 is made of quartz with thickness of 20 nm. As shown in FIG. 13 and FIG. 14, the electric actuating layer 102 of the unit cell 100 is of different height, resulting in different focal points of the zoom reflective metalens in corresponding states.

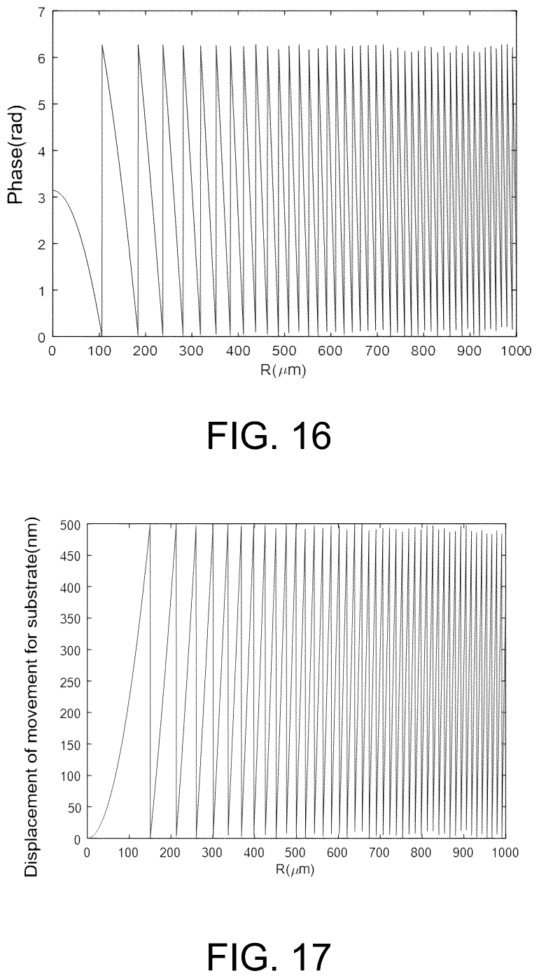

In one embodiment, the caliber of the reflective zoom metalens is 2 mm. When the focal length of the reflective zoom metalens is 6 mm, the phase along the radius is shown in FIG. 15. When the focal length of the reflective zoom metalens is 12 mm, the phase along the radius is shown in FIG. 16. When the focal length of the zoom reflective metalens changes from 6 mm to 12 mm, the displacement of movement for the electrical actuating layer 102 along the radius is shown in FIG. 17.

In conclusion, according to the unit cell, phase-tunable metasurface and optical system provided by the present disclosure, the electrical actuating layer can move under the action of the electric field provided by the electrode layer. And the electrode layer is setting on the both sides of the electrical actuating layer. And then the electrode layer drives the nanostructure to move in the height axial direction, so as to modulate phase of the unit cells by modulating the nanostructure. Modulating the nanostructure can achieve an active modulation of the phase-tunable metasurface. The metasurface of the present disclosure includes the unit cells mentioned above, and the modulation of the unit cell can utilize a wide range of the phase modulation to the metasurface. Since any one unit cell can be modulated, the phase-tunable metasurface provided by the embodiment of the present disclosure can realize a precise phase modulation.

The above is only a specific embodiment of the embodiment of this disclosure, but the scope of protection of the embodiment of this disclosure is not limited to this, and any person familiar with the art can easily think of change or substitution, which should be covered within the protection scope of the embodiment of this disclosure. Therefore, the scope of the protection of the present disclosure shall be the scope of the claim.

What is claimed is:

1. A unit cell, wherein the unit cell comprises: an electrode layer, an electrical actuating layer and a nanostructure;
wherein, the nanostructure is a sub-wavelength structure;
the electrode layers are setting on the both sides of the electrical actuating layer;
the nanostructure is setting on the one side of the electrode layer away from the electrical actuating layer;
the electrical actuating layer is capable of moving in the height axial direction of the nanostructure under the action of the electric field provided by the electrode layer.

2. The unit cell according to claim 1, wherein the unit cell further comprises: a reflective layer;
wherein, the reflective layer is set on the side of the electrode layer facing the incident light;
the nanostructure is setting on the side of the reflective layer away from the electrode layer.

3. The unit cell according to claim 2, wherein the unit cell further comprises: a matching layer;
wherein, the matching layer is setting on the side of the reflective layer away from the electrode layer;
the nanostructure is setting on the side of the matching layer away from the reflective layer.

4. The unit cell according to claim 1, wherein a periodicity of the unit cell is greater than or equal to 0.3 λc, and less than or equal to λc;
λc is the central wavelength of the incident light.

5. The unit cell according to claim 1, wherein a height of the nanostructure is greater than or equal to 0.3 λc, and less than or equal to λc;
λc is the central wavelength of the incident light.

6. The unit cell according to claim 2, wherein a thickness of the reflective layer is greater than or equal to 30 nm, and less than or equal to 200 nm.

7. The unit cell according to claim 3, wherein a thickness of the matching layer is greater than or equal to 10 nm, and less than or equal to 200 nm.

8. The unit cell according to claim 1, wherein the electrical actuating layer comprises: MEMS or piezoelectric ceramics.

9. The unit cell according to claim 1, wherein the extinction coefficients for the incident light of the electrode layer and the electrical actuating layer are less than or equal to 0.1.

10. The unit cell according to claim 1, wherein the electrical actuating layer comprises: indium tin oxide.

11. The unit cell according to claim 1, wherein a thickness of the electrode layer is greater to 10 nm.

12. A phase-tunable metasurface, wherein the phase-tunable metasurface comprises the unit cell according to claim 1.

13. The phase-tunable metasurface according to claim 12, wherein the unit cells are arranged in array.

14. The phase-tunable metasurface according to claim 12, the phase-tunable metasurface further comprises: a filler material, the filler material is configured to fill a gap between any two nanostructures in the metalens;
wherein, the filler material comprises fluid with an extinction coefficient less than or equal to 0.1 for the incident light.

15. The phase-tunable metasurface according to claim 14, the filler material is air.

16. The phase-tunable metasurface according to claim 14, the filler material is non-air fluid;
the absolute value of the difference between the refractive index of the non-air fluid and the nanostructure is greater than or equal to 0.5.

17. The phase-tunable metasurface according to claim 14, the height of the electrical actuating layer is greater than or equal to 10 times of the central wavelength of the incident light.

18. The phase-tunable metasurface according to claim 14, wherein, the movement of the electrical actuating layer in the height axial direction satisfies at least:
$${n}_{F} ( {λ}_{c} ) \cdot Δ d \geq \frac{{λ}_{c}}{2}$$
wherein, the n_{F}(λ_{c}) is the refractive index of the filler material of the incident light at the central wavelength; Δd is the maximum displacement of movement for the electrical actuating layer, λ_{c} is the central wavelength of the incident light.

19. The phase-tunable metasurface according to claim 12, the maximum displacement of movement for the electrical actuating layer is less than or equal to 500 nm.

20. An optical system, wherein, the optical system comprises the phase-tunable metasurface according to claim 12.
